(19) United States
(12) Patent Application Publication
(10) Pub. No.: US 2008/0108518 A1
(43) Pub. Date: May 8, 2008

(54) METHOD OF REMOVING DISPERSED SULFUR FROM SULFUR-CONTAINING FLUIDS

(76) Inventors: J. Caleb Clark, Sugar Land, TX (US); Stephen J. Homer, Richmond, TX (US); Kailash Sawhney, Sugar Land, TX (US); Frank A. Cosman, Calgary (CA)

Correspondence Address: Michael B. Martin;Patent and Licensing Department, Nalco Company, 1601 West Diehl Road, Naperville, IL, 60563-1198, US

(21) Appl. No.: 11/555,973

(22) Filed: Nov. 2, 2006

(51) Int. Cl. C09K 8/02

(52) U.S. Cl. 507/90

(57) ABSTRACT

This invention is a method of using sulfite salts to remove dispersed sulfur from fluids encountered in oil and gas production, transport and refining in which sulfite salts are used to convert the dispersed sulfur into benign, water-soluble sulfur species which remain in aqueous solution. Sulfur precipitation and deposition in conduits and processing equipment is thereby prevented.

### TECHNICAL FIELD

This invention relates to methods of using sulfite salts to remove dispersed sulfur from fluids and/or inhibit precipitation of the sulfur from fluids and deposition of the precipitated sulfur on conduits and separation equipment used in oil and gas production, transport and refining operations.

### BACKGROUND OF THE INVENTION

Sulfur is produced with natural gas and crude oil in the elemental form and as sulfides, polysulfides, mercaptans and other organic and inorganic species. The deposition of elemental sulfur results in a constriction of flow and accumulation and reduced capacity in separation equipment. When produced in conjunction with water, elemental sulfur is highly corrosive to the carbon steel piping and separation equipment typically used in oil and gas production, transportation and refining operations. Elemental sulfur can also interact with production treating chemicals to form tars or gunks.

Elemental sulfur solubility in natural gas is a function of many factors including the pressure and temperature of the gas in the formation, pressure reduction and cooling in the production piping, the concentration of sulfur species such as H₂S, and amount of liquid hydrocarbon associated with gas production. Other factors include the volume and salinity of water and the concentration of carbon dioxide in the gas. Typically as the pressure and temperature of the natural gas falls from the formation into the production equipment, the solubility of sulfur also falls. Elemental sulfur precipitation can also occur as the result of air contamination or the interaction of sulfide species with oxidized forms of iron.

Various methods have been used to prevent the precipitation of elemental sulfur including preventing oxygen ingress into oil and gas production and handling operations, designing production equipment to minimize the potential deposition of elemental sulfur, heating production to maintain liquid sulfur, periodic or continuous injection of solvents to remove sulfur deposits or prevent sulfur deposition, batch applications of solvents to remove deposits, squeeze applications of solvents to remove sulfur deposits in the formation, continuous injection of dispersants to keep precipitated elemental sulfur mobile in the water phase, coating internal surfaces of equipment and diluting sour gas with sweet gas.

Types of solvents used to remove or prevent sulfur deposits are typically categorized as Physical Solvents and Chemical Solvents. Physical solvents include hydrocarbons such as mixtures of polycyclic aromatics, coker gas oil, aromatic solvents such as toluene, mineral oil, and aliphatics. Chemical solvents include amine based chemicals such as aqueous ethylamine and alkyl amines in aromatic solvents, and disulfide based solvents such as dimethyl disulfide, diaryl disulfide, and dialkyl disulfide mixtures such as Merox.

The amount of solvent and method of application are unique to each system and their application is not without challenges. In gas production operations the solvents are produced with the gas to the gas plant. In many cases the specific gravity of the solvent loaded with elemental sulfur can be higher than the specific gravity of the produced water resulting in separation and handling problems at the gas plant. In addition the under-injection of solvent can result in the downstream precipitation of additional elemental sulfur as the production cools. Each of the solvents has specific handling challenges. The disulfide based solvents have a noxious odor and are very difficult to handle. Coker gas oil also has a bad odor and other solvents are linked to environmental, health and/or safety issues. The application of solvents is typically once through. This can result in a large expense associated with sulfur management.

Accordingly, there is an ongoing need for new safe, practical and economical methods of removing sulfur from hydrocarbon fluids.

### SUMMARY OF THE INVENTION

In an embodiment, this invention is a method of inhibiting the deposition of sulfur in conduits and equipment used in oil and gas production, transportation, separation and refining operations from sulfur-containing fluids being transported or processed in said conduits and equipment comprising adding an effective deposition inhibiting amount of an aqueous solution of one or more sulfite salts to said fluids.

In another embodiment, this invention is a method of removing dispersed or entrained sulfur from fluids comprising the dispersed or entrained sulfur, hydrocarbon and water comprising

i) adding one or more sulfite salts to the fluids in an amount sufficient to convert the dispersed or entrained sulfur into water-soluble sulfur species, wherein said water-soluble sulfur species form an aqueous solution in said water; and ii) separating the water from the hydrocarbon.

### DETAILED DESCRIPTION OF THE INVENTION

This invention provides improved methods of inhibiting the deposition of sulfur in conduits and equipment used in oil and gas production, transportation, separation and refining operations from sulfur-containing fluids being transported or processed in said conduits and equipment. For purposes of this invention, “sulfur-containing fluids” means fluids containing sulfur species which are insoluble in the fluids under the conditions in which the fluids are being transported or processed such that the sulfur species are entrained or dispersed in the fluids and prone to precipitation or deposition onto the transportation or processing equipment. Sulfur species suitable for treatment according to this invention include elemental sulfur and 0-valent polymeric sulfur species. In some embodiments, the sulfur is elemental sulfur.

In the method of this invention, sulfite salts are used to convert sulfur species dispersed or entrained in the fluids into benign water-soluble sulfur species comprising thiosulfate salts which can then be maintained in aqueous solution for disposal by standard means. For example, in the case of natural gas or crude oil production, the sulfur species are solubilized and transported in produced water to the separation system for disposal with the produced water.

As used herein, “inhibiting” encompasses both preventing and inhibiting. “Produced water” includes both produced and condensed water.

Suitable sulfite salts include those having the formula MₓSO₃ and hydrates thereof where M is an inorganic or organic cation and x is 1 or 2.

In some embodiments, the sulfite salts are selected from the group consisting of alkali metal, alkaline earth and ammonium sulfite salts.

In some embodiments, the sulfite salt is sodium sulfite.

In some embodiments, the sulfite salt is ammonium sulfite.

Representative fluids include natural gas, crude oils, sour distillates, sour condensates and the like. “Natural gas” means a normally gaseous mixture of hydrocarbons, at least at ambient surface conditions of temperature and pressure, containing principally methane but also containing lesser amounts of carbon dioxide as well as other light hydrocarbons such as ethane, ethylene, propane, butane or even higher hydrocarbons.

In some embodiments, the fluid is crude oil.

In some embodiments, the fluid is natural gas.

In some embodiments, the sulfite salts are formulated as an aqueous solution for treating the hydrocarbon fluid. The concentration of the sulfite salt is limited only by the solubility of the salt in the aqueous solution. In general, the concentration of salt is selected such that the aqueous solution in combination with any water present in the hydrocarbon fluid be sufficient to allow for solubilization of the sulfur species so that the sulfur species may be separated from the hydrocarbon fluid as an aqueous solution.

In some embodiments, the aqueous solution sulfite salt solution has a concentration of about 15 to about 40 weight percent of the sulfite salts.

In some embodiments, the conduits and equipment are used in crude oil or gas production.

In some embodiments, the aqueous sulfite solution is injected continuously into the fluid.

The rate of injection of the aqueous solution into the treated hydrocarbon fluid may be empirically determined based on the weight of expected or proven sulfur precipitation from the hydrocarbon fluid. As noted above, it is preferred that water be present with the production to carry the sulfite salt and dissolved sulfur.

The sulfite salts may be added to conduits and equipment together with or prior to passage of the fluids through the conduits or processing in the equipment. In the case of produced hydrocarbon fluids, especially natural gas, the aqueous sulfite salt solution may be added continuously to the gathering equipment prior to, just as or after the fluid reaches the wellhead. The sulfite salts may also be added downhole, for example by an injection string, or at the wellhead.

The choice of sulfite salt and its effective dose can be determined empirically based on the characteristics of the and/or system being treated, for example using the methods described herein. In a typical application, the fluid or system is treated with about 0.1 to about 10 moles of sulfite salt per mole of sulfur present in the fluid or system although in certain cases the dosage can range up to about 100 moles or more of sulfite salt.

While the sulfite salts are preferably used as the sole treatment for preventing deposition of sulfur it may be advantageous in certain instances to use the sulfite salts in combination with one or more sulfur dispersants. Sulfur dispersants are known in the art. Representative dispersants include, but are not limited to quaternary ammonium compounds, alcohols, hydrocarbons, and the like.

As noted previously, when produced in conjunction with water, elemental sulfur is highly corrosive to carbon steel piping and equipment. Thus, the presence of even substantially reduced sulfur deposits resulting from treatment of sulfur-containing fluids with sulfite salts according to this invention may pose a corrosion risk. Accordingly, in an alternative embodiment of this invention the sulfite salts are employed in combination with a corrosion inhibitor to reduce the deposition of sulfur and the corrosion of the internal surfaces of a pipelines and equipment through which a sulfur-containing fluid is passing or being processed. Corrosion inhibitors are known in the art. Representative corrosion inhibitors include, but are not limited to imidazolines, quaternary ammonium compounds, phosphate esters, and the like.

The sulfite salts may also be used in combination one or more additional treatments used in the production and/or transport of hydrocarbon fluids including, but not limited to thermodynamic hydrate inhibitors, kinetic hydrate inhibitors and/or anti-agglomerates, asphaltine inhibitors, paraffin inhibitors, scale inhibitors, emulsion breakers and the like.

The foregoing may be better understood by reference to the following example, which is presented for purposes of illustration and is not intended to limit the scope of this invention.

### EXAMPLE

One-gram samples of sulfur and 20 g of water are placed in two ounce bottles and stirred magnetically. Various alcohols and quaternary ammonium salts are added as necessary to assist in dispersion of the sulfur. A 15% aqueous solution of sodium sulfite or ammonium sulfite is then added to the bottles in weighed amounts.

The solutions are then stirred at 80° C. for 30 minutes. After this time, the dispersed sulfur is collected by vacuum filtration and weighed. The weights are used to calculate the percent sulfur consumption. The results are shown in the following Tables.

TABLE 1

| Sulfite salt | | |
|---|---|---|
| (15% aqueous solution) | Wt. Added (g) | % Sulfur consumption |
| Na₂SO₃ | 20 | 65 |
| Na₂SO₃ | 22.5 | 71 |
| Na₂SO₃ | 25 | 75 |
| Na₂SO₃ | 27.5 | 82 |
| Na₂SO₃ | 30 | 88 |
| (NH₄)₂SO₃ | 2.5 | 21 |
| (NH₄)₂SO₃ | 5 | 51 |
| (NH₄)₂SO₃ | 7.5 | 69 |
| (NH₄)₂SO₃ | 10 | 96 |
| (NH₄)₂SO₃ | 12.5 | 100 |

As shown in Table 1, representative sulfite salts according to the invention effectively solubilize dispersed sulfur in fluid samples.

Changes can be made in the composition, operation, and arrangement of the method of the invention described herein without departing from the concept and scope of the invention as defined in the claims.

1. A method of inhibiting the deposition of sulfur in conduits and equipment used in oil and gas production, transportation, separation and refining operations from sulfur-containing fluids being transported or processed in said conduits and equipment comprising adding an effective deposition inhibiting amount of an aqueous solution of one or more sulfite salts to said fluids.

2. The method of claim 1 wherein said sulfur in said sulfur-containing fluid is elemental sulfur.

3. The method of claim 2 wherein the sulfite salts are selected from the group consisting of alkali metal, alkaline earth and ammonium sulfite salts.

4. The method of claim 3 wherein the sulfite salt is sodium sulfite.

5. The method of claim 3 wherein the sulfite salt is ammonium sulfite.

6. The method of claim 1 wherein the fluid is selected from the group consisting of natural gas, crude oils, sour distillates and sour condensates.

7. The method of claim 1 wherein the conduits and equipment are used in crude oil or gas production.

8. The method of claim 7 wherein the aqueous solution is added continuously to the fluid.

9. The method of claim 8 wherein the aqueous solution is added to the fluid downhole or at the wellhead.

10. The method of claim 1 further comprising adding one or more sulfur dispersants to the fluid.

11. The method of claim 1 further comprising adding one or more corrosion inhibitors to the fluid.

12. A method of removing dispersed or entrained sulfur from fluids comprising the dispersed or entrained sulfur, hydrocarbon and water comprising
i) adding one or more sulfite salts to the fluids in an amount sufficient to convert the dispersed or entrained sulfur into water-soluble sulfur species, wherein said water-soluble sulfur species form an aqueous solution in said water; and
ii) separating said water from said hydrocarbon.

13. The method of claim 12 wherein said sulfur in said sulfur-containing fluid is elemental sulfur.

14. The method of claim 12 wherein said sulfite salts are added as an aqueous solution.

15. The method of claim 12 wherein the sulfite salts are selected from the group consisting of alkali metal, alkaline earth and ammonium sulfite salts.

16. The method of claim 15 wherein the sulfite salt is sodium sulfite.

17. The method of claim 15 wherein the sulfite salt is ammonium sulfite.

18. The method of claim 14 wherein the aqueous sulfite salt solution is added continuously to the fluids.

19. The method of claim 18 wherein the fluids are generated in crude oil or gas production.

20. The method of claim 19 wherein the aqueous sulfite salt solution is added downhole or at the wellhead.

21. The method of claim 12 further comprising adding one or more sulfur dispersants to the fluid.

22. The method of claim 12 further comprising adding one or more corrosion inhibitors to the fluid.
